(19) United States
(12) Patent Application Publication
(10) Pub. No.: US 2008/0078258 A1
(43) Pub. Date: Apr. 3, 2008

(54) MULTI-COMPONENT PIPETTE TIP AND ASSOCIATED METHODS

(76) Inventors: West L. Price, Draper, UT (US); Zackary J. Jensen, West Valley City, UT (US); Tyler W. Caldwell, Sandy City, UT (US); Fredrick C. Steed, Hurricane, UT (US)

Correspondence Address: TRASK BRITT, P.O. BOX 2550, SALT LAKE CITY, UT, 84110, US

(21) Appl. No.: 11/862,840

(22) Filed: Sep. 27, 2007

Related U.S. Application Data
(60) Provisional application No. 60/847,820, filed on Sep. 28, 2006.

(51) Int. Cl. B01L 3/00; B29C 45/00

(52) U.S. Cl. 73/864.01; 264/294

(57) ABSTRACT

Described are pipette tips and methods of making the same. The pipette tips may include at least two components, an annular component and a tubular body component. The annular component may comprise a different and relatively more compliant material. The annular component may be partially or entirely telescopically received within the tubular body component. Alternatively, the annular component may comprise a proximal end of the pipette tip and the tubular body component may comprise a distal end of the pipette tip. A portion of the tubular body component may be telescopically received by the annular component or otherwise attached thereto. The pipette tip may be formed by first molding the annular component and next molding the tubular body component. Alternatively, the tubular body component may be molded first and the annular component may be molded within, adjacent, or about the tubular body component.

### CROSS-REFERENCE TO RELATED APPLICATION

This application claims the benefit of the filing date of U.S. Provisional Patent Application Ser. No. 60/847,820, filed Sep. 28, 2006, for “TWO-PART MOLDED PIPETTE TIP” (MULTI-COMPONENT PIPETTE TIP AND ASSOCIATED METHODS), the entire disclosure of which is incorporated herein by this reference.

### TECHNICAL FIELD

This invention relates generally to pipette tips, including methods of making or using an improved version of such tips.

### BACKGROUND

Pipette tips are conventionally, either manually or robotically, manipulated for use individually or to register with the individual wells of well assay plates. Well assay plates comprise individual wells (analogous to miniature test tubes) organized in ranks and files in standardized patterns.

To manipulate a tip, a probe may be inserted into its interior, whereby creating a physical connection between the probe and the tip. Pipette tips are typically characterized by an internal passageway defined by a tapered inner wall. The insertion of a cylindrical probe into such a tip creates an interference fit. Properly mounting the pipette tip on the probe effects a fluid-tight seal between the peripheral cylindrical surface of the probe and the tapered inner wall of the pipette tip. In practice, the taper of the passageway in the pipette tip does not reliably effect precise sealing and alignment of the pipette tip with the probe. In addition, the force needed to load the pipette tip on the probe is not reliably consistent.

According to established procedures, the mounting shaft of a probe is driven axially into the tip a distance deemed sufficient to create a fluid-tight seal between the tip and the mounting shaft and to assure lateral stability between the tip and the mounting shaft. This operation inherently requires some deformation of the annular cross-section of the tip. Pipette tips have conventionally been formed of a rigid plastic material. The annular deformation of the pipette tip required to accommodate movement of the tip onto the shaft sufficiently to create a fluid-tight seal with lateral stability is difficult to achieve and requires a large axial mounting force.

Conventional automated probes are commonly specifically designed for use with pipette tips of a standard volume. Pipette tips of similar volume obtained from different manufacturers differ significantly from each other in shape and other details of construction. The tips of each manufacturer are correlated, by details of construction, to selected probes; they are thus not suitable for use on non-correlated probes. Use of non-correlated pipette tips on any of the currently available probes introduces a number of practical concerns. An ineffective seal may result. Unique insertion and removal forces will usually be required, and these forces may not be determinable without considerable effort. Improper axial alignment and position are also probable. As a practical matter, tips from a single source may not be used interchangeably with probes from multiple suppliers.

Pipette tips are conventionally formed of a non-reactive material, for example, polypropylene or high-density polyethylene. The pipette tip must be sufficiently rigid for axial stability when mounted on a manual or automatic probe and when ejected from the probe. Mounting a pipette tip on a probe requires the exertion of an axial (usually downward) force to drive the probe a sufficient axial distance into the tip. Achieving the annular deformation required of the pipette tip to generate a sufficient interference fit may require a force exceeding twenty pounds (9 kilograms). A force of that magnitude is unachievable for many individuals, making manual operation problematic. The greater the axial force exerted in mounting the pipette tip, the greater the force necessary to eject the tip from the probe.

Numerous pipette tips have been designed to overcome these difficulties. For example, a pipette tip having one or two annular rings extending around the interior wall of the pipette tip for sealing with cylindrical flat portions of a probe is described in U.S. Pat. No. 5,232,669 to Pardinas, the disclosure of which is incorporated herein by this reference. However, the pipette tip of Pardinas requires the probe to include cylindrical flat portions and a shoulder for engaging a rim of the pipette tip and limiting movement of the probe into the pipette tip. Without properly limiting axial movement, the annular rings will not be aligned with the cylindrical flat portions, and the sealing function of the annular rings is not assured. Thus, the pipette tip of Pardinas is specifically suitable for use only with a pipette including a specific correlated probe.

U.S. Pat. No. 6,197,259 to Kelly et al., the disclosure of which is incorporated into this disclosure by this reference, describes a pipette tip including lateral stabilizing means on an inner surface of the pipette tip for engaging the outer surface of a mounting shaft as it is inserted into the pipette tip. The lateral stabilizing means may comprise three circumferentially spaced contacts extending inwardly from the inner surface of the tip. An annular sealing region further within the pipette tip is designed to engage a lower end of a sealing zone of the mounting shaft, and to stretch radially outward as the mounting shaft is guided and oriented in position to create a fluid-tight seal. Thus, mounting the pipette tip of Kelly requires sufficient axial probe force to radially distort the pipette tip.

A need exists for a pipette tip that forms a fluid-tight seal with a probe upon application of relatively low axial mounting force. The tip should also be laterally stable when mounted, and offer a universal fit for use interchangeably with the pipette probes obtained from different manufacturers.

### BRIEF SUMMARY OF THE INVENTION

This invention provides a pipette tip with different selected physical properties in different segments along its length. According to certain preferred embodiments, the tip is constructed of a plurality of components, each of which is formed of materials selected to provide specified physical properties. In a typical construction, a first component is formed as a tubular body having a first proximal end segment and a second distal end segment. A second annular component is positioned coaxially with respect to the first component. The second component may be partially or entirely telescopically positioned with respect to the first component. Materials of construction are selected such that the second component is relatively more compliant than is the first component. The second component may comprise an elastomer, for example, a thermoplastic vulcanizate. The first component may comprise, for example, polypropylene. The first component may be tapered, with its proximal end segment having a diameter greater than the diameter of its distal end segment. The proximal end segment of the first component may include an outwardly extending flange, and a plurality of circumferentially spaced apertures through a side wall of the first component. Optionally, the first component may include circumferentially spaced longitudinally extending fins on its outer surface. According to one typical embodiment, a pipette tip of this invention comprises a tubular body having a first proximal end segment and a second distal end segment. The inside-facing surface of the proximal end segment is more compliant than is the inside-facing surface of the distal end segment.

One suitable method of forming a pipette tip of this invention comprises providing an injection-molding chamber with multiple sources of injection material. The injection material of a first such source is selected to produce finished components of relatively compliant characteristics, and the injection material of a second such source is selected to produce finished components having relatively rigid characteristics. A first mold may be utilized in generally conventional fashion to form an annular inner component of the pipette tip from material provided from the first source. That tubular inner component is then moved to a position adjacent the second source of injection material. A second mold is then utilized to form a tubular pipette tip body from material provided from the second source. The annular component may be at least partially telescopically received within and molded to the tubular pipette tip body. Alternatively, the tubular pipette tip body may be at least partially telescopically received within and molded to the tubular pipette tip body.

An alternative method of forming a pipette tip comprises providing an injection-molding chamber with two sources of injection material, injecting a first mold with the injection material of the first of the two sources of injection material to form a first component of the pipette tip, and forming an annular second component at least partially telescopically received within and optionally molded to the outer component. The injection material of the first of the two sources of injection material may have relatively rigid characteristics subsequent to molding and the injection material of a second of the two sources of injection material may have relatively compliant characteristics subsequent to molding. The first component may include a tapered tubular body having apertures circumferentially spaced about a distal end segment. A mold material may be injected through the apertures of the first component to form the annular second component.

In yet another method of forming a pipette tip, an annular second component may be molded with a first tubular body at least partially telescopically received within.

As used in this disclosure, the term “compliant” refers to physical properties that comply with the requirements of a fluid-tight seal. Materials exhibiting varying degrees of elasticity, resilience, hardness and related properties will be relatively more compliant or more rigid. In the context of this invention, the degree of rigidity required for a tip to be suitable for manipulation in a typical pipetting operation drives the manufacturers of such tips to select molding materials that are relatively more rigid and relatively less compliant. Incorporating a component formed from relatively more compliant material, in accordance with this invention, provides a more compliant interface between a probe and a tip, thereby reducing the mounting force required to effect a fluid-tight seal.

### BRIEF DESCRIPTION OF THE DRAWINGS

In the drawings, which illustrate what is currently regarded as the best mode for carrying out the invention:

FIG. 1 is an illustration of a first embodiment of a pipette tip of the present invention;

FIG. 2 is an illustration of the outer component of the pipette tip of FIG. 1;

FIG. 3A illustrates the inner component of FIG. 1;

FIG. 3B depicts a perspective view of the inner component of FIG. 1;

FIG. 4 is a perspective view of a second embodiment of a pipette tip of the present invention;

FIG. 5 is an illustration of a third embodiment of a pipette tip of the present invention;

FIG. 6 depicts a fourth embodiment of a pipette tip of the present invention, mounted on a pipette;

FIG. 7A depicts a fifth embodiment of a pipette tip of the present invention;

FIG. 7B depicts a close-up view of the junction of a first component and a second component of the pipette tip of FIG. 7A;

FIG. 7C shows a pipette tip mounting shaft and ejection mechanism;

FIG. 8 depicts a mold of the present invention; and

FIG. 9 illustrates a flow chart for a method of making a pipette tip of the present invention.

### DETAILED DESCRIPTION OF THE INVENTION

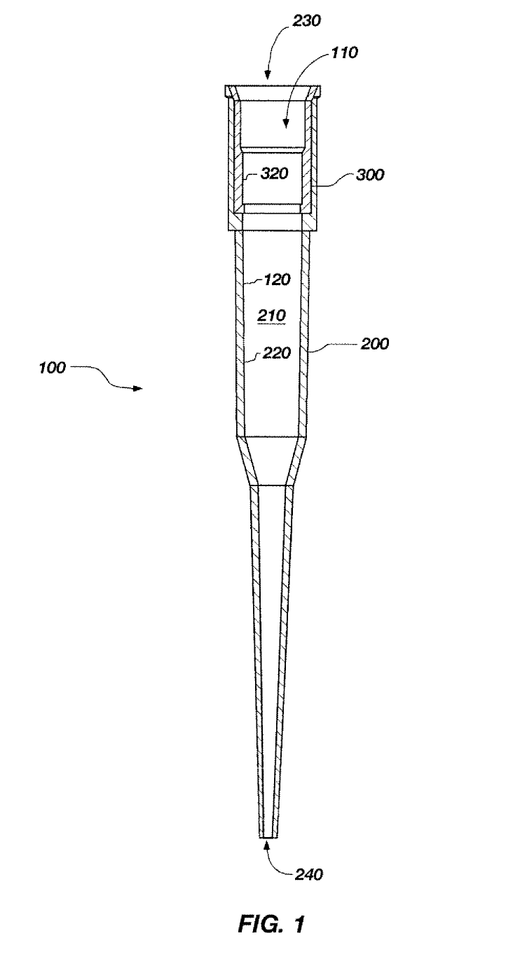

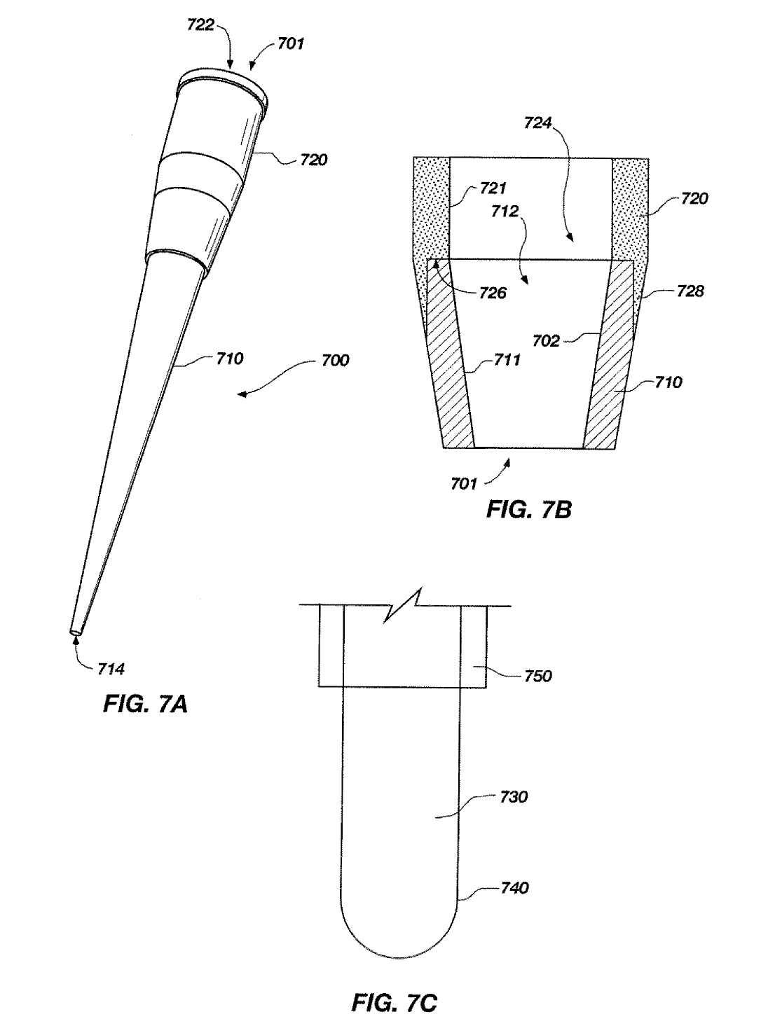

FIG. 1 depicts a first embodiment of a pipette tip, generally 100, of the present invention. The pipette tip 100 comprises a hollow, elongated, tapered body 200 (also “outer component 200”) with a proximal open end 230 for receiving and releasably mating with a mounting shaft of a manual or mechanical pipette device (see FIG. 7C).

The pipette tip 100 comprises two components respectively formed of materials selected for their distinct but different properties. An outer component 200, shown as a hollow, elongated, tapered body, telescopically receives an inner component 300. For convenience of description, the outer component 200 is referred to as “tapered.” Within the context of this disclosure, however, the term “tapered” refers to an overall reduction in diameter throughout the length of the body. The outer component 200 may, in practice, include cylindrical segments. In any case, outer component 200 has an interior wall 220 defining an inner passageway 210. The proximal open end 230 of outer component 200 is of greater diameter than the distal open end 240. The proximal open end 230 is configured to receive the inner component 300 and the mounting shaft of a pipette device. The distal open end 240 is configured to draw a liquid into the inner passageway 210.

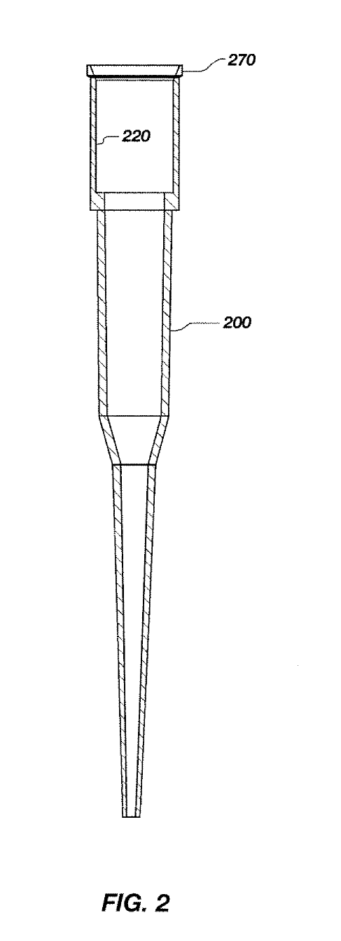

The outer component 200, shown in detail in FIG. 2, includes a rim or flange 270, which protrudes beyond the inner component 300 (FIG. 1), and extends radially outward from the remainder of the outer component 200.

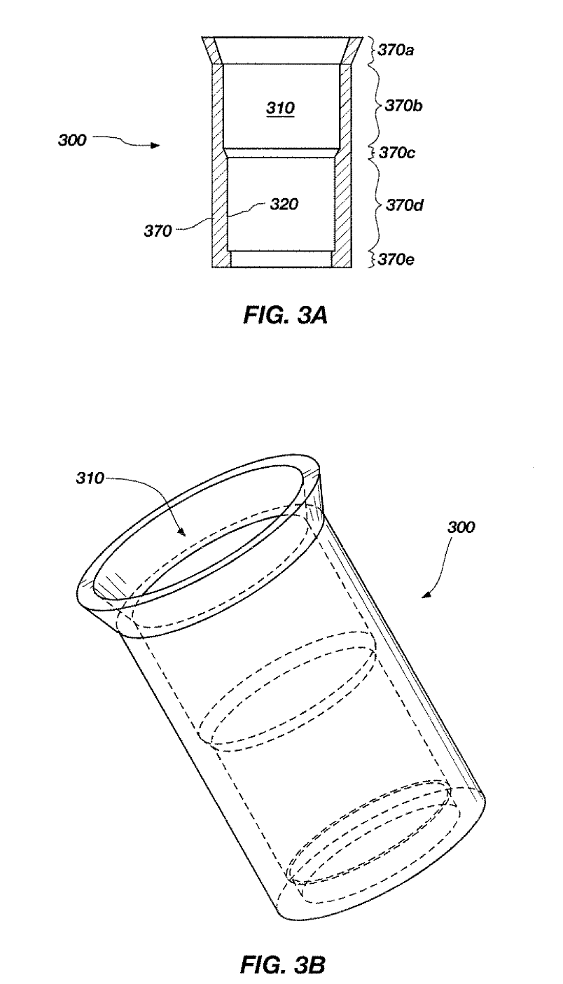

As illustrated, the inner component 300 of the pipette tip is generally annular. It may comprise a separate, generally cylindrical component, as shown, but in other embodiments, may comprise a coating on an interior wall 220 of the outer component 200. The inner component 300 may cover only an end segment of the interior wall 220, proximal to proximal open end 230. The embodiment of inner component 300 (shown in detail in FIGS. 3A and 3B) comprises an annular body 370 defining a passageway 310 and comprising a plurality of segments 370a, 370b, 370c, 370d, and 370e. The passageway 310 decreases in diameter from a first end segment 370a to a second end segment 370e. The first end segment 370a defines a tapered section of the passageway 310. The adjacent segment 370b defines a cylindrical portion of the passageway 310. A third segment 370c defines a tapered portion of the passageway 310, and the next adjacent segment 370d defines a second cylindrical section of the passageway with a diameter smaller than the first cylindrical section. The passageway 310 is thereby configured to receive the mounting shaft of a pipette in fluid-tight sealed relationship. Alternative embodiments have passageways 310 configured to present a uniformly tapered interior wall, a cylindrically shaped interior wall, or any number of tapered or cylindrical sections, provided that they are shaped and dimensioned to effect a fluid-tight seal with the mounting shaft of a pipette probe. The material from which the inner component 300 is constructed is ideally sufficiently compliant to deform as required to receive and seal about the mounting shaft.

Returning to FIG. 1, the pipette tip 100 comprises a tapered, tubular body with a passageway 110 therethrough. The passageway 110 is defined by an inside-facing surface 120. The inside-facing surface 120 includes a first portion 220, corresponding to the inside-facing surface of the outer component 200. A second portion 320 of the inside-facing surface 120 of the pipette tip 100 corresponds to the inside-facing surface of the inner component 300. The material of the inner component 300 is different than the material of the outer component 200. The material of the inside-facing surface first portion 220 is, therefore, different than the material of the inside-facing surface second portion 320. The inside-facing surface second portion 320 may comprise a compliant material, and be configured to receive and sealingly engage with a mounting shaft of a pipette.

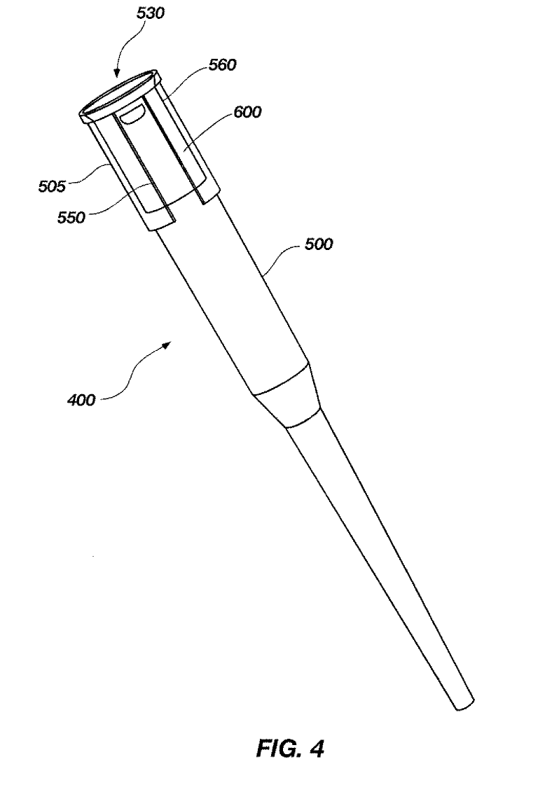

A second embodiment of a pipette tip of the present invention is shown in FIG. 4. The pipette tip 400 includes an outer component 500 and an inner component 600. The outer component 500 includes circumferentially spaced longitudinally extending fins 550 on the outer surface 505. The fins 550 provide lateral stability. The outer component 500 further includes circumferentially spaced apertures 560 about a first open end 530 thereof. The apertures 560 may be useful for the formation of the pipette tip 400, as described in further detail subsequently in this disclosure.

The inner component 300, 600 may comprise an elastomer, such as a rubber, a foam, a thermoplastic elastomer (TPE), or a thermoplastic vulcanizate. A TPE combines the look, feel and elasticity of conventional thermoset rubber with the processing efficiency of a plastic. The melt-processability makes it suitable for high-volume injection molding and extrusion. One suitable thermoplastic vulcanizate is sold under the trade name SANTOPREME™ by Santopreme Specialty Products of Akron, Ohio.

The pipette tip outer component 200, 500 may comprise, by way of example, polypropylene or polystyrene. The pipette tip outer component 200, 500 is preferably resilient enough to be ejected off of a pipette probe, and to have lateral and dimensional stability.

FIG. 7C depicts the mounting shaft 730 of a pipette with an ejection mechanism 750 disposed about the shaft. In use, the mounting shaft 730 may be inserted within the pipette tip 100, 400 with enough force to deform the compliant material of the inner component 300, 600, forming a fluid-tight seal between the mounting shaft peripheral cylindrical surface 740 and the second portion of inside-facing surface 320 of the inner component 300, 600. Fluid may be drawn into the pipette tip 100, 400 with a vacuum through the mounting shaft 730, and the fluid may be expelled, for example, in a different location. The fluid may be drawn in through and expelled from the distal open end 240 of the pipette tip 100, 400. The pipette tip 100, 400 may be pushed off of the mounting shaft 730 with the ejection mechanism 750. The ejection mechanism 750 may comprise an annular body. The mounting shaft 730 may be an element of a manual or an automated pipette.

The compliant material of the inner component 300, 600 enables the pipette tip 100, 400 to be mounted on the pipette device with little or no deformation of the more rigid material of the outer component 200, 500. Therefore, the axial mounting and ejection forces are minimized. In addition, the compliant material of the inner component 300, 600 enables the pipette tip 100, 400 to have a universal fit. That is, the pipette tip 100, 400 of the present invention may be mounted on the mounting shafts of various pipette devices, despite the differing shaft diameters of those devices. For example, a pipette tip 100, 400 having an inner component passageway with a diameter of about 0.172 inches (0.437 centimeters) at the largest open end may fit a pipette-mounting shaft having a diameter between about 0.173 inches (0.438 centimeters) and about 0.183 inches (0.465 centimeters). The material of the inner component may have a durometer between about 50 and about 60, preferably about 55 on the Å scale, and the material may be compressed a maximum of between about 40% and about 65%. Therefore, an inner component having a wall thickness of about 0.010 inches (0.025 centimeters) and a maximum compression of 50% may fit a pipette-mounting shaft having a diameter up to about 0.010 inches (0.025 centimeters) larger tan the inner component passageway.

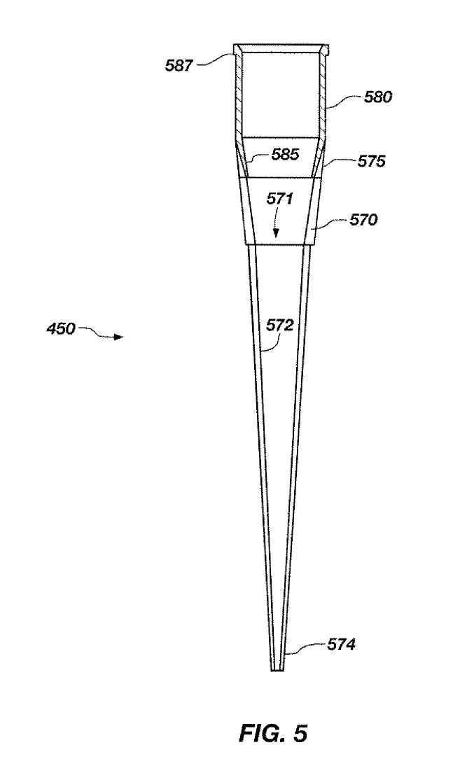

FIG. 5 depicts a third embodiment of a pipette tip 450 of the present invention. The pipette tip 450 comprises at least two components. The two components shown are formed of different materials having correspondingly different physical properties. The outer component 570 comprises a hollow, elongated, tapered body, with a portion of a second, annular inner component 580 received telescopically therein. The outer component 570 has an interior wall 572 defining a passageway 571. A first, proximal end segment 575 of the outer component 570 has an opening greater in diameter than the opening of a second, distal end segment 574. The segment 575 is configured to receive a first end segment 585 of the inner component 580. A second end segment 587 of the inner component 580 is configured to receive the mounting shaft of the pipette device. The segment 574 of the outer component 570 is configured to draw a liquid into the passageway 501. The segment 587 of the inner component 580 protrudes beyond the outer component 570.

The inner component 580 may comprise an elastomer, such as a rubber, a foam, a thermoplastic elastomer (TPE), or a thermoplastic vulcanizate. The pipette tip inner component 580 is preferably resilient enough to be ejected off of a pipette probe, yet compliant enough to form a fluid-tight seal therewith. The material of the second component may have a durometer between about 60 and about 95, preferably about 87 on the Å scale.

The pipette tip outer component 570 may comprise, by way of example, polypropylene or polystyrene, The pipette tip outer component 570 is preferably relatively more resilient and/or rigid than the material of the inner component 580.

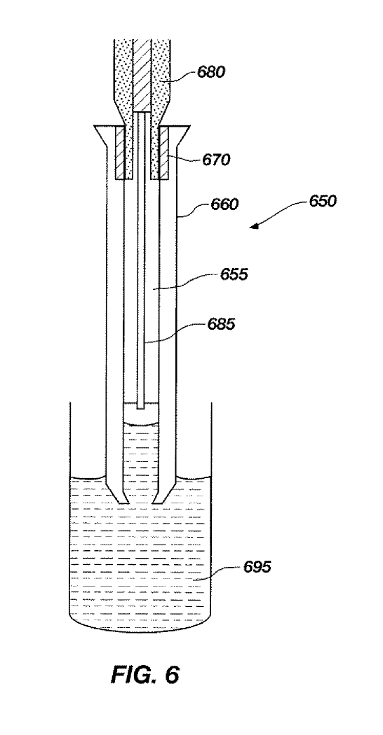

FIG. 6 depicts an alternative embodiment of a pipette tip 650 of the present invention. The pipette tip 650 is a positive displacement pipette tip. It includes an outer component 660 and an inner component 670, each of which may be formed of the materials disclosed as useful in connection with other embodiments of the invention. The inner component 670 is fashioned of a more compliant material than is the outer component 660. The pipette tip 650 is depicted mounted on a pipette 680. The pipette 680 includes a plunger 685 that may be used to draw a liquid 695 into the pipette tip 650, and to dispense the liquid 695 from the pipette tip 650. The pipette tip 650 may have a substantially cylindrical passageway 655 therethrough, with an inside-facing surface of the inner component 670 flush with an inside-facing surface of the outside component 660.

FIGS. 7A and 7B depict an additional embodiment of a pipette tip 700 of the present invention. The pipette tip 700 includes a first component 710 and a second component 720. The first component 710 may comprise a hollow, elongated, tapered body of a relatively more rigid material than the material of the second component 720. The first component may be axially tapered from a first open end 712 (see FIG. 7B) to a second open end 714. The second component 720 may comprise a hollow, substantially cylindrical body with a first open end 722 to a second open end 724 (see FIG. 7B). The second open end 724 of the second component 720 may be configured to telescopically receive the first component 710 therein. The second component 720 may include an annular rim 726 for abutting with the first component 710, and an annular flange 728 for encircling a portion of the same. FIG. 7B depicts a cross-sectional view of the junction of the first component 710 and the second component 720. The inside-facing surface 721 of the second component 720 at the second open end 724 and the inside-facing surface 711 of the first component 710 at the first open end 712 may adjoin to form a substantially continuous interior surface of the pipette tip 700.

The pipette tip 700 comprises a tapered, tubular body with a passageway 701 therethrough. The passageway 701 is defined by an inside-facing surface 702. The inside-facing surface 702 includes a first portion corresponding to the inside-facing surface 711 of the first component 710. A second portion of the inside-facing surface 721 of the pipette tip 700 corresponds to the inside-facing surface of the second component 720. The material of the second component 720 is different than the material of the first component 710. The material of the inside-facing surface first portion 711 is, therefore, different than the material of the inside-facing surface second portion 721. The inside-facing surface second portion 721 may comprise a compliant material and be configured to receive and sealingly engage with a mounting shaft of a pipette.

In use, the pipette tip 450, 700 may be mounted on a mounting shaft 730 (FIG. 7C) of a pipette. The mounting shaft 730 may be inserted within component 580, 720 of pipette tip 450, 700. The component 580, 720 deforms to form an annular fluid-tight seal between the mounting shaft 730 and the component 580, 720. Fluid may be drawn into the pipette tip 450, 700 with a vacuum through the mounting shaft 730, and the fluid may be expelled, for example, in a different location. The fluid may be drawn in through and expelled from an opening of the second end 574, 714 of the pipette tip component 570, 710.

The pipette tip of the present invention may be formed by two-shot molding, also known as double-shot molding, insert molding and over-molding. The inner component may be molded first and the outer component may then be molded around the inner component. Alternatively, the outer component may be molded first, and the inner component may then be molded within the outer component.

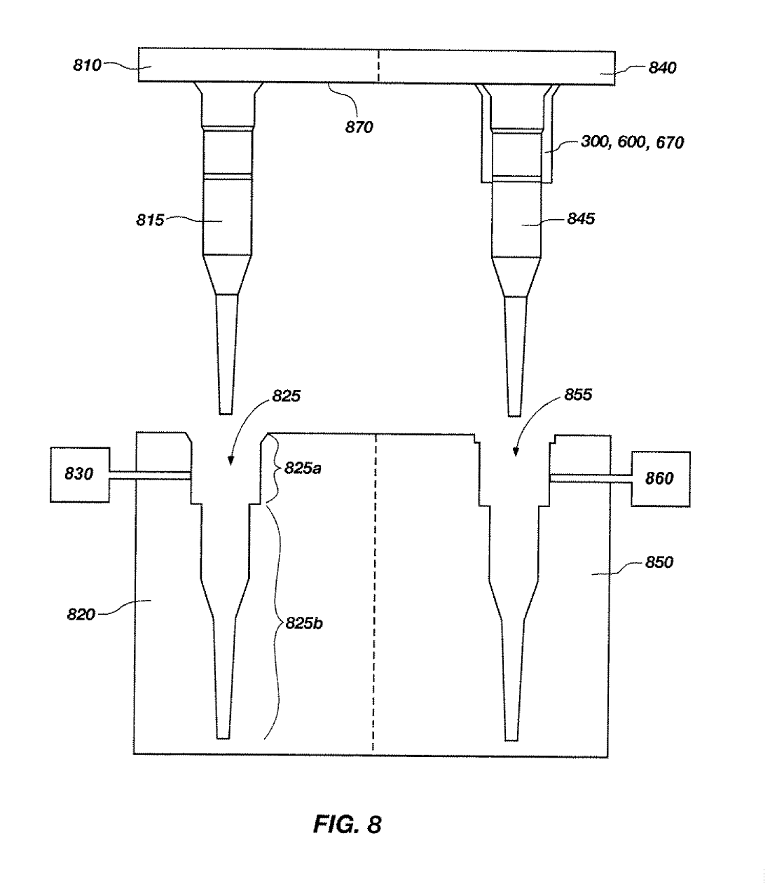

As shown in FIG. 8, two mold plates may be provided for a practical molding process. The inner component 300, 600, 670 are molded between a first plate 810 and a second plate 820. The first plate 810 may include a protrusion 815, also known as a core, configured to define the inner surface configuration of component 300, 600, 670. The second plate 820 includes a cavity 825 for receiving the protrusion 815, thereby defining a cavity closely approximating the size and shape of inner component 300, 600, 670. The protrusion 815 is thus configured to define the passageway through the pipette tip 100, 400, 650. A first portion 825a of the cavity 825 is configured to define the outside surface of the inner component 300, 600, 670. A second portion 825b of the cavity 825 may be configured to receive the protrusion 815 with a relatively tight tolerance therebetween. Thus, no molding cavity is created between the protrusion 815 and the cavity second portion 825b. In use, the protrusion 815 may be disposed within the cavity 825, forming a molding cavity to form the inner component 300, 600, 670 of a pipette tip 100, 400, 650. A first molding material may be inserted into the molding cavity from a first molding material source 830.

Subsequent to the formation of the inner component 300, 600, 670, the first plate 810 may be drawn away from the second plate 820. The protrusion 815 with the inner component 300, 600, 670 formed thereabout may thus be removed from the cavity 825.

A third plate 840 is shown, having a protrusion 845 with the inner component 300, 600, 670 formed thereabout. The third plate 840 may be pressed against a fourth plate 850; the fourth plate 850 including a cavity 855 therein. The cavity 855 may be configured for receiving the protrusion 845 and the inner component 300, 600, 670 creating a mold cavity for forming the outer component 200, 500, 660. A second molding material may be inserted into the molding cavity from a second molding material source 860.

The second plate 820 and the fourth plate 850 may comprise a contiguous plate for use with an injection-molding machine having a rotating platen 870. The first plate 810 and the third plate 840 may be a part of the rotating platen 870. After forming the inner component 300, 600, 670 within the cavity 825 of the second plate 820, the first plate 810 with the first component 300, 600, 670 positioned about the protrusion 815 may be drawn away from the second plate 820, rotated, and the mold may be closed with the first plate 810 against the fourth plate 850, and the outer component 200, 500, 660 may be formed therein.

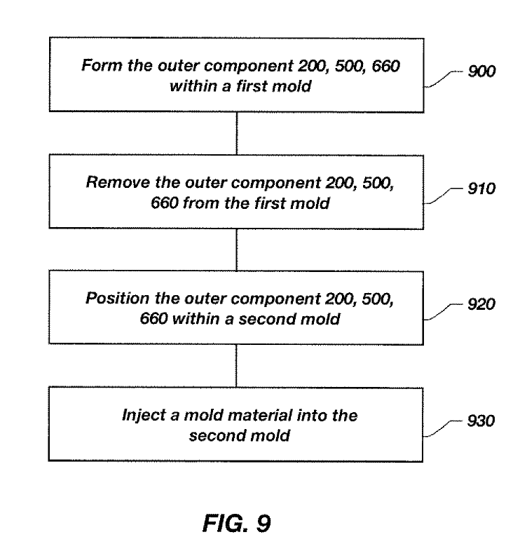

FIG. 9 depicts a flow chat for another method of making a pipette tip 100, 400, 650 of the present invention. The pipette tip 100, 400, 650 may be formed by insert molding. In step 900, the outer component 200, 500, 660 may be formed within a cavity of a first mold, about a first mold core. Next, in steps 910 and 920, the outer component 20, 500, 660 is removed from the first mold cavity, and positioned within a second mold cavity. The outer component 200, 500, 660 may be disposed between a second core and the cavity of the second mold. The second core may include a portion thereof having a diameter smaller than the diameter of the first mold core. A mold material may be injected into the second mold in step 930, and the inner component 300, 600, 670 may be formed between the second core and the outer component 200, 500, 650. The inner component 300, 600, 670 may be bonded to the outer component 200, 500, 650 by molecular bonding of the material of the components, during the molding or with a thermal weld. Alternatively, or in addition to the molecular bonding, mechanical bonding may take place. For example, the outer component 200, 500, 650 may include surface irregularities, which are surrounded by the material of the inner component 300, 600, 670, or shrinking or swelling of the material of the components may take place.

While this invention has been described in certain embodiments, the present invention can be further modified within the spirit and scope of this disclosure. The formation of the pipette tip 100, 400, 650 of the present invention has been described using two-shot molding, forming the inner component, and subsequently forming the outer component about the inner component. However, it will be understood by one skilled in the art that other methods of forming a multi-component pipette tip are within the scope of the present invention. For example, the outer component may be formed prior to the inner component, or other molding methods may be used to form the multiple components. The term “pipette tip” as used herein, is intended to encompass all types of pipette tips, including pipette tips used for automated and manual pipetting, positive displacement pipettes, and all other pipette tips.

This application is, therefore, intended to cover any variations, uses, or adaptations of the invention using its general principles. For example, it is within the scope of the present invention for the inner component 300 shown in FIG. 1 to comprise an O-ring or a sealing ring. Further, this application is intended to cover such departures from the present disclosure as come within the known or customary practice in the art to which this invention pertains and which falls within the limits of the appended claims.

What is claimed is:

1. A pipette tip, comprising:
a first tubular component constructed of a first moldable material, having a proximal end and a distal end; and
a second annular component disposed coaxially with respect to said first tubular component and comprising a material relatively more compliant than said first moldable material.

2. The pipette tip of claim 1, wherein the second annular component comprises a coating on a portion of an inside-facing surface of said first tubular component.

3. The pipette tip of claim 1, wherein said second annular component is formed from material comprising a thermoplastic vulcanizate.

4. The pipette tip of claim 1, wherein said proximal end of said first tubular component includes an outwardly extending flange.

5. The pipette tip of claim 1, wherein said first tubular component comprises polypropylene.

6. The pipette tip of claim 1, wherein said first tubular component is tapered to progressively smaller diameters from said proximal end to said distal end.

7. The pipette tip of claim 1, wherein said first tubular component has at least one aperture through a side wall of said distal end.

8. The pipette tip of claim 1, wherein said first tubular component further comprises circumferentially spaced longitudinally extending fins on an outer surface thereof.

9. The pipette tip of claim 1, wherein said first tubular component is at least partially telescopically positioned with respect to said second annular component.

10. A pipette tip, comprising:
an outer component comprising a tapered body defining an internal passageway; and
an annular inner component received within said internal passageway and comprising a relatively more compliant material.

11. The pipette tip of claim 10, wherein said annular inner component comprises a thermoplastic vulcanizate.

12. The pipette tip of claim 10, wherein said outer component includes a plurality of circumferentially spaced apertures disposed thereabout.

13. The pipette tip of claim 10, wherein the outer component comprises polypropylene.

14. A method of forming a pipette tip, comprising;
providing an injection molding chamber with sources of first and second injection materials, said first injection material having relatively compliant characteristics subsequent to molding;
injecting a first mold with said first injection material to form an annular component of the pipette tip;
transferring said annular component to a position adjacent a source of said second injection material; and
injecting a second mold wit said second injection material to form a tubular pipette tip body positioned coaxially with respect to said annular component and attached thereto.

15. The method of claim 14, wherein said second injection material has relatively rigid characteristics subsequent to molding.

16. The method of claim 14, wherein said tubular pipette tip body is mold bonded to said annular component.

17. The method of claim 14, wherein said first injection material comprises a thermoplastic vulcanizate.

18. The method of claim 14, wherein said second injection material comprises a polypropylene material.

19. The method of claim 14, wherein said first mold comprises a tapered cavity within a molding plate and a protrusion of another molding plate receivable within said tapered cavity and contacting a bottom surface of said tapered cavity.

20. The method of claim 14, comprising forming the tubular pipette tip body telescopically with respect to a portion of said annular component.

21. A method of forming a pipette tip, comprising:
providing an injection-molding chamber with two sources of injection material;
injecting a first injection material from a first of said sources to form a tubular pipette tip body; and
injecting a second injection material from a second of said sources to form an annular body coaxial with and attached to said tubular pipette tip body.

22. The method of claim 21, wherein said first injection material has relatively rigid characteristics subsequent to molding and said second injection material has relatively compliant characteristics subsequent to molding.

23. The method of claim 21, wherein said tubular pipette tip body is formed with apertures through its side wall and said second injection material is injected rough said apertures.

24. A method of forming a pipette tip, comprising:
molding a tubular body defining an internal passageway;
disposing said tubular body over a mold core to form an annular gap between an outer surface of said mold core and a portion of an inner surface of said tubular body; and
injecting a mold material into said annular gap to form an inner component telescopically within said tubular body.

25. A pipette tip comprising a tapered, tubular body having an inside-facing surface defining a passageway therethrough, wherein a first portion of the inside-facing surface comprises a first material, and a second portion of the inside-facing surface comprises a second material having different physical properties than said first material.
